(19) United States
(12) Patent Application Publication
(10) Pub. No.: US 2022/0324368 A1
(43) Pub. Date: Oct. 13, 2022

(54) Automatic Single Point Release System

(71) Applicant: Capewell Aerial Systems LLC, South Windsor, CT (US)

(72) Inventors: Stephen T. Parkinson, Suffield, CT (US); Adam J. Fitzgerald, Enfield, CT (US)

(21) Appl. No.: 17/226,733

(22) Filed: Apr. 9, 2021

(51) Int. Cl. B60P 3/079; B64D 1/12

(52) U.S. Cl. CPC B60P 3/079; B64D 1/12

(57) ABSTRACT

Disclosed herein is an automatic single point release system including a platform, a plurality of securement modules mounted to said platform, each said module including, a first strap anchored to said platform, a second strap anchored to said platform, and a latch connected between the first strap and the second strap, wherein the latch includes a releasable latch arm, a rocker arm, and a control cable, wherein the control cable is configured to control a position of the rocker arm, and wherein the latch arm is configured to be attachable and releaseable to a payload on the platform in response to the position of the rocker arm. A control box mounted to the platform, wherein the control box is connected to each control cable, wherein the control box is configured to automatically and concurrently release each said latch in response to a predetermined condition.

### BACKGROUND

This disclosure relates generally to aerial delivery systems. More specifically, this disclosure relates to automatic systems employed for securing cargo to a platform and for releasing the cargo from the platform.

For aerial delivery systems to which the disclosure relates, a cargo is secured to a platform which is loaded into the aircraft. The platform is extracted from the aircraft by an extraction parachute. Suspension parachutes are subsequently opened to complete the aerial delivery. The cargo is secured to the platform by various techniques which may, for example, include flexible straps secured around the cargo and placed in tension. For aerial delivery which involves land delivery, upon landing of the cargo, the straps are released to obtain access or usage of the cargo. For aerial delivery of vehicles, the number of straps employed vary depending on weight and configuration of the payload. The straps are latched about the wheels, axles, or other connection points at the underside of the vehicle. Upon landing of the platform, typically, each of the four latch assemblies is independently released so that the cargo vehicle may be unloaded from the platform.

U.S. Pat. No. 8,414,235 describes a Single Point Release system which allows a series of latches to be simultaneously released from a single control lever. The manually actuated control lever disclosed in U.S. Pat. No. 8,414,235 is suitable for various applications, however in other applications it is desired to have the capability for dropping payloads autonomously, or remotely operated. Accordingly, there is a need for an improved single point release system.

### SUMMARY

Briefly stated, an automatic single point release system comprises a platform, a plurality of securement modules mounted to said platform, each said module comprising, a first strap anchored to said platform, a second strap anchored to said platform, and a latch connected between the first strap and the second strap, wherein the latch comprises a releasable latch arm, a rocker arm, a control cable, wherein the control cable is configured to control a position of the rocker arm, and wherein the latch arm is configured to be attachable and releaseable to a payload on the platform in response to the position of the rocker arm; a control box mounted to the platform, wherein the control box is connected to each control cable, wherein the control box is configured to automatically and concurrently release each said latch in response to a predetermined condition.

### BRIEF DESCRIPTION OF THE DRAWINGS

FIG. 1 is a perspective view of an aerial delivery platform incorporating an automatic single point release system;

FIG. 2 is a perspective view of a control box in a locked position of the system shown in FIG. 1;

FIG. 3 is a side view of a latch of the system shown in FIG. 1 in a locked position;

FIG. 4 is a perspective view of the control box shown in FIG. 2 in a released position;

FIG. 5 is a side view of the latch shown in FIG. 3 in a released position;

FIG. 6 is an alternate embodiment of the latch shown in FIG. 3 in the locked position;

FIG. 7 is an alternate embodiment of the latch shown in FIG. 3 in the released position; and

FIG. 8 is a block diagram of a control circuit of the system shown in FIG. 1.

### DETAILED DESCRIPTION

With reference to the drawings wherein like numerals represent like parts throughout the several Figures, an automatic single point release (ASPR) system for an aerial delivery system is generally designated by the numeral 10. The release system 10 functions to provide a single point for efficiently concurrently and automatically releasing the cargo retaining latches for an aerial delivery system. The automatic single point system is adapted to provide a quick release for land based delivery and a more reliable release for mid-air release requirements, such as for a rigid inflatable boat. The automatic single point release system is employed in conjunction with an airdrop platform 12 which may be Type V or any other platform employed for aerial delivery.

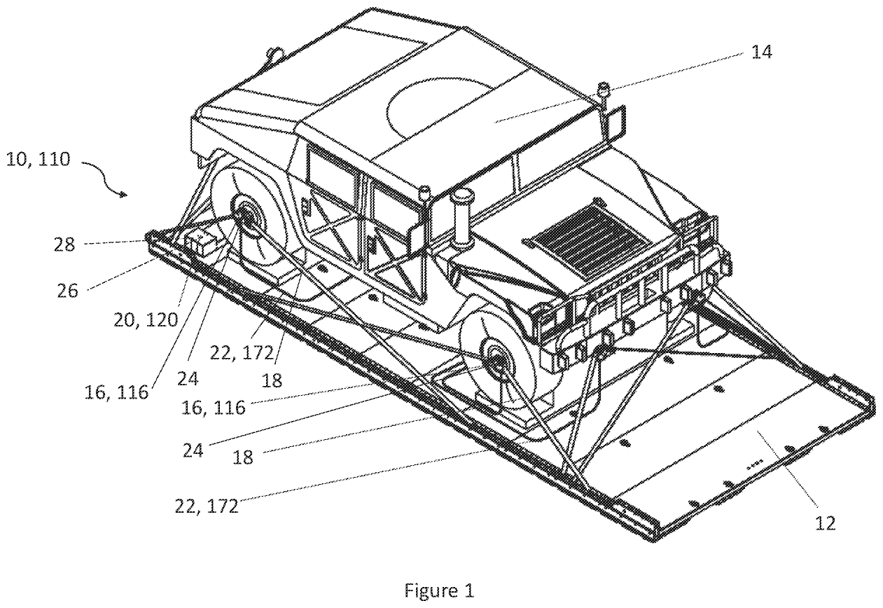

FIG. 1 shows an exemplary embodiment of the system 10 installed on the airdrop platform 12 with a typical payload 14. In this example, the representative payload 14 comprises a vehicle, however in other examples any suitable payload may be provided, such as, for example cargo loaded on pallets and/or platforms. The system 10 includes several latches 16 attached to the payload 14, with straps (such as tie-down straps, for example) 18 fastened to the latch 16 and platform 12. This arrangement restrains the payload 14 from unwanted motion relative to the airdrop platform 12. Each latch 16 is connected to the control box 20 via a control cable 22.

The Automatic Single Point Release (ASPR) system 10 is configured to automatically release the restraints fastening the airdrop payload to an airdrop platform based on sensor input to meet predetermined release conditions.

As such, the ASPR latches 16 are attached to clevises 24 (or equivalent tie down provisions) located on an airdrop payload 14. In this example, the each of the latches 16 are attached to the clevis (or equivalent tie down provision) 24 proximate a wheel of the vehicle, however in alternate embodiments, any suitable location or attachment point for the latch may be provided.

The latch straps 18 are then fastened to the airdrop platform 12 and tensioned. Each latch 16 is then connected to the control box 20, which includes sensors 26 and a control circuit 28. The control circuit 28 monitors the sensors 26 and determines when release conditions have been met. The control circuit then triggers the ASPR latches 16 to release the payload 14.

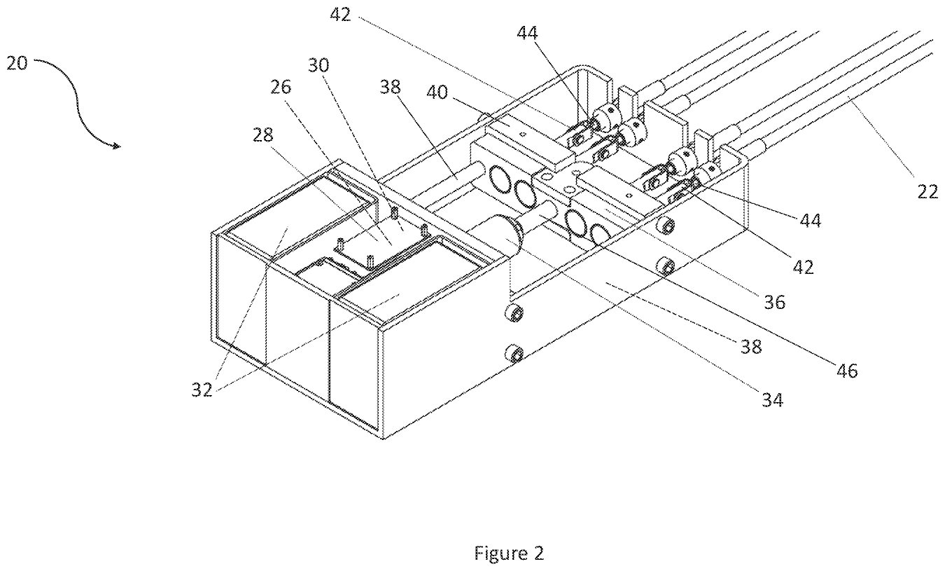

Referring now also to FIG. 2, there is shown a perspective view of the control box 20 with the cover (or covers) removed to show internal components of the control box 20 (however, for the purposes of clarity, various electrical connectors and/or wiring is not shown).

The control box 20 includes the sensors 26, the control circuit (or logic circuit) 28, a timer 30, a power supply 32 (such as batteries, for example), and means of triggering the latches. In this embodiment, the control box 20 uses mechanical cables to trigger the latches 16 to release. The control box 20 further comprises a linear actuator 34 connected to a movable bridge (or driver bridge) 36, guide rails 38, and a fixed guide 40. The guide rails 38 are provided at opposite ends of the driver bridge 36 (with only one guide rail visible in the perspective view of FIG. 2). The guide rails 38 are configured to maintain proper orientation and/or alignment of the driver bridge 36 relative to the fixed guide 40. The driver bridge 36 further comprises rods 42 which extend through an opening (or openings) of the fixed guide 40 and connect to a corresponding inner wire 44 of the latch control cable 22 (which allows for all of the cables 22 to be pulled/released simultaneously).

Still referring to FIG. 2, the ASPR control box 20 is connected to the mechanical cables 22 and is shown in a ‘locked’ position. In this ‘locked’ position the linear actuator 34 is configured such that a piston 46 of the linear actuator 34 is fully extended so as to have the movable bridge 36 adjacent the fixed guide 40, thus providing reduced tension on the mechanical cables 22. It should be noted that in this embodiment four cables are shown, however in other embodiments a greater number (or any suitable number) of cables is also envisioned depending on payload requirements. Additionally, with the driver bridge 36 attached to both the actuator piston 46 and each inner wire 44 of the cables 22, the bridge 36 can also be secured with safety pin as physical backup to the control circuit logic, to prevent inadvertent actuation in aircraft.

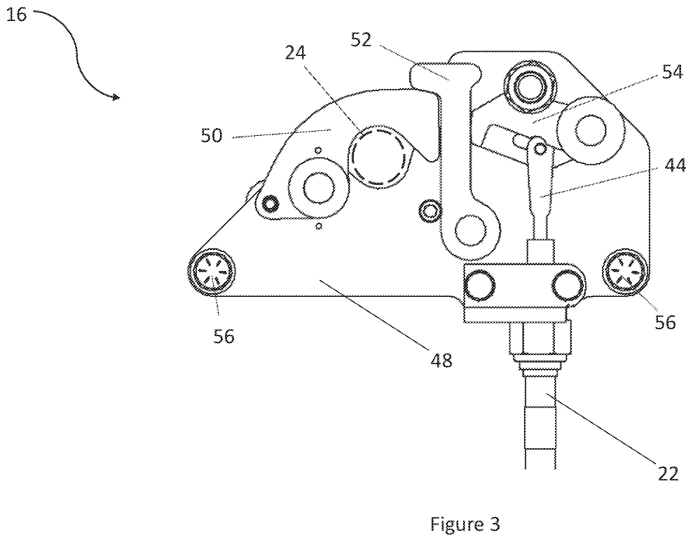

Referring now also to FIG. 3, a side view of one of the latches 16 is shown. The latch 16 comprises a main body portion 48, a latch arm 50, a lever arm 52, a rocker arm 54, and tie-down attachment points 56. The side view of the latch is shown with a side plate removed to show internal components.

The latch arm 50, the lever arm 52, and the rocker arm 54 are all pivotably connected to the main body portion 48 of the latch 16. The latch arm 50 is configured to fit around a portion of the corresponding clevis 24 (or equivalent tie down provision) in the closed position while the lever arm 52 secures the latch arm 50 in the closed position (as shown in FIG. 3). Additionally, in this ‘locked’ position the rocker arm 54 (which is connected to the inner wire 44 of the cable 22) prevents the lever arm 52 from rotating which keeps the latch arm secured around the portion of the clevis (or equivalent tie down provision). The main body portion 48 of the latch 16 further comprises the tie-down attachment points 56 at opposite ends of the latch 16. These attachment points are configured to be connected to the straps 18 (shown in FIG. 1).

With the control box in the ‘locked’ position as shown in FIG. 2, this provides for the ‘locked’ position of the latch as shown in FIG. 3 due to the connection of the inner wire 44 of the cable 22 between the control box 20 and the latch 16.

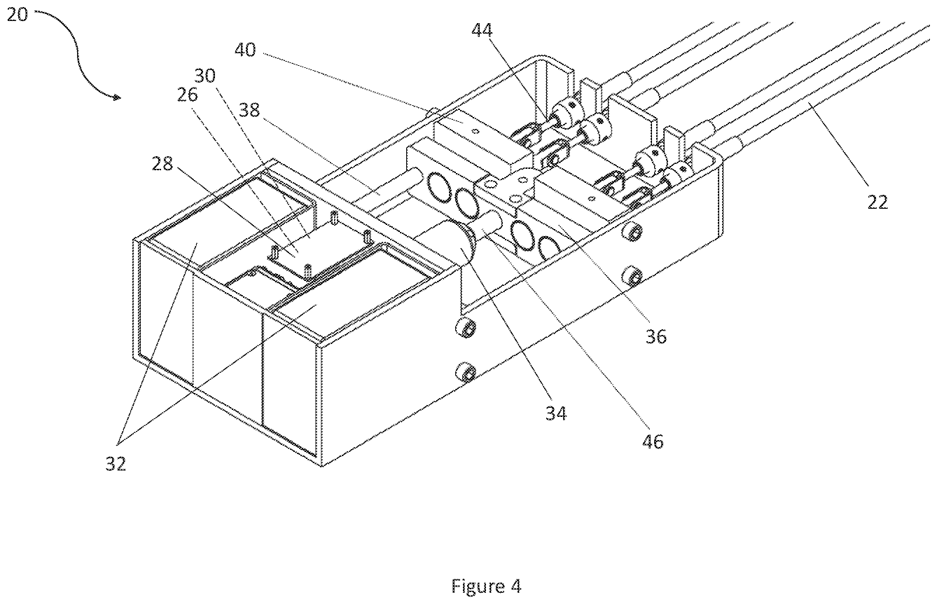

FIG. 4 shows control box of FIG. 2 in a ‘released’ position with the actuator retracted to tension the cables. For example, when the piston of the electrical actuator 34 is retracted this moves the bridge component 36 to tension all of the mechanical control cables 22 at once, which allows the four latches to release simultaneously. According to various exemplary embodiments, the control circuit board together with the sensors/timer are configured to determine when to retract actuator piston.

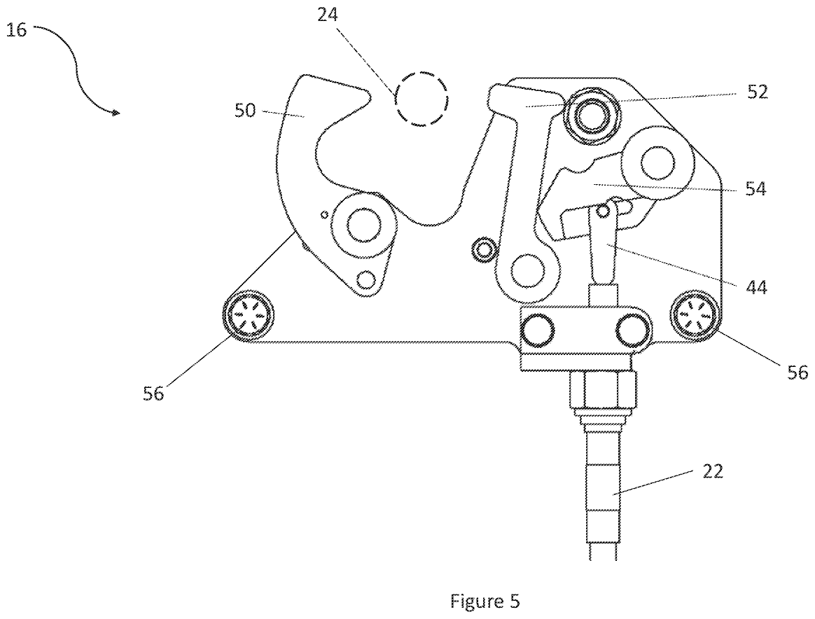

Referring now also to FIG. 5, there is shown the latch in the open/released position in response to the control cable being tensioned (as shown in FIG. 4). For example, the tensioned inner wire of the mechanical cable moves rocker arm to the released position. With the rocker arm in the released position, this allows the lever arm to rotate. Further, when the lever arm rotates away from latch arm, the latch arm is free to rotate (as shown in FIG. 5) and releases from the clevis (or equivalent tie down provision) 24.

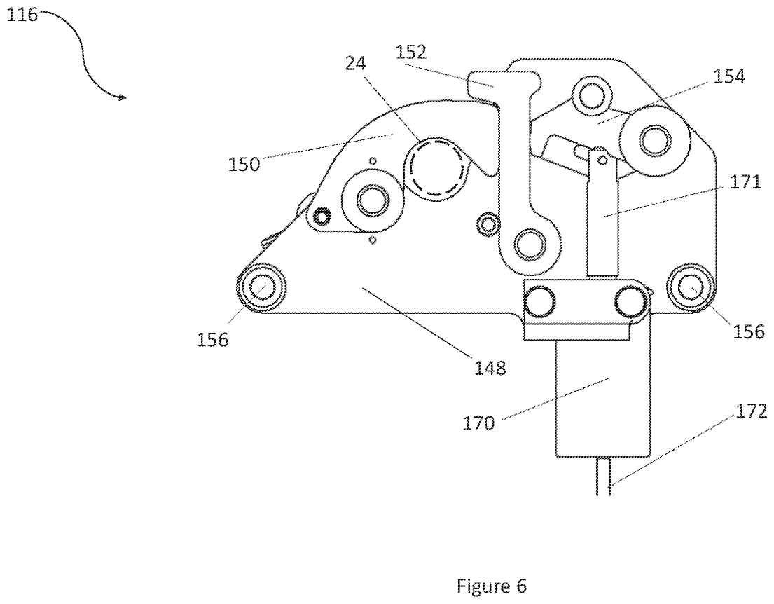

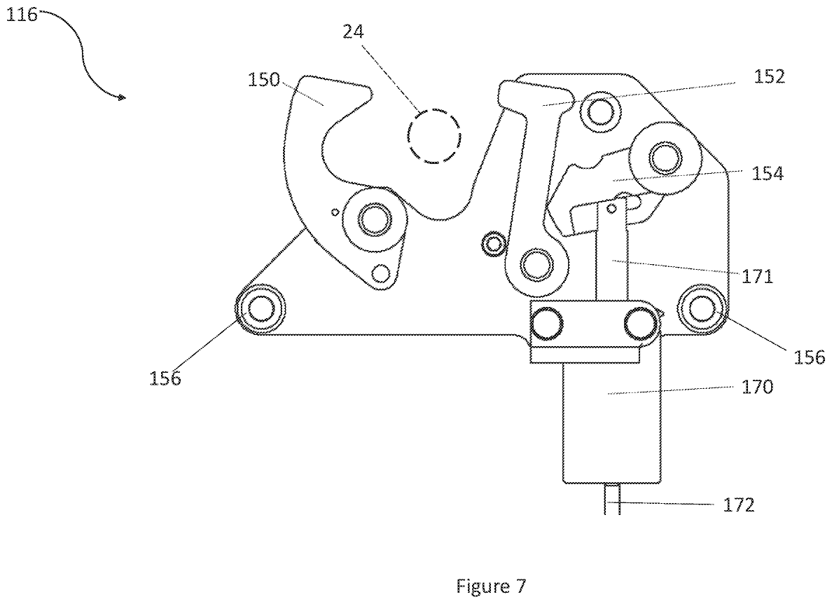

Referring now also to FIGS. 6 and 7, there is shown a latch 116 according to an alternate embodiment of the automatic single point release system. The automatic single point release system 110 is similar to the automatic single point release system 10, however instead of the mechanical control cables (and corresponding features) of the automatic single point release system 10, the automatic single point release system 110 comprises electrical control cables. The latch 116 is similar to the latch 16 and includes a main body portion 148, a latch arm 150, a lever arm 152, a rocker arm 154, and tie-down attachment points 156, which are all similar to the main body portion 48, the latch arm 50, the lever arm 52, the rocker arm 54, and the tie-down attachment points 56 of the latch 16. However in this embodiment, a linear actuator (or solenoid or similar electromechanical device) 170 and an electrical cable 172 replace the mechanical cable and corresponding configuration shown in FIGS. 2-5. Additionally, the control box 120 corresponding to this embodiment includes the sensors 26, the control circuit (or logic circuit) 28, the timer 30, and the power supply 32 similar to the control box 20, however in this embodiment the control box 120 does not require the linear actuator, the movable bridge, the guide rails 38, the fixed guide, and the mechanical cables (as the electrical cables [or electrical control cables] 172 which are connected to the control circuit are provided in this embodiment).

Similar to the ‘locked’ position of the latch 16 in FIG. 3, the latch 116 is shown in a ‘locked’ position where the latch arm 150 is configured to fit around a portion of the corresponding clevis 24 (or equivalent tie down provision) in the closed position while the lever arm 152 secures the latch arm 150 in the closed position. Additionally, in this ‘locked’ position the rocker arm 154 (which is connected to an extended actuator piston 171 of the linear actuator 170) prevents the lever arm 152 from rotating which keeps the latch arm secured around the portion of the clevis (or equivalent tie down provision). According to various exemplary embodiments, power may be supplied to the linear actuator by the electrical cable 172 or via a battery within the latch (not shown).

FIG. 7 shows the latch in the ‘released’ position. Similar to the ‘open/released’ position of the latch 16 in FIG. 5, the latch 116 is shown in a ‘open/released’ position where the actuator 170 retracts the piston 171 upon receiving a trigger signal from the control box 120. The retraction of the piston 171 of the actuator 170 moves the rocker arm to the released position. With the rocker arm in the released position, this allows the lever arm to rotate. Further, when the lever arm rotates away from latch arm, the latch arm is free to rotate (as shown in FIG. 5) and releases from the clevis (or equivalent tie down provision) 24.

Technical effects of any one or more of the exemplary embodiments provide significant improvements over conventional configurations including replacing the manually actuated control lever with an electrically controlled release means. As described above, in one embodiment the release means typically includes one electric actuator connected to the latches via mechanical control cables. In another embodiment, each individual latch includes an electric actuator, with the control box supplying a trigger signal. According to the various exemplary embodiments, the sensors may include pressure altimeter, accelerometers, or timer, to determine when the release means should trigger.

Additional technical effects of any one or more of the exemplary embodiments, provide reliable configurations when there is a need to drop payloads which can be autonomous, or remotely operated. In conventional configurations these payloads cannot be airdropped without support personnel because there is no means of releasing the payload from the airdrop platform. The various exemplary embodiments disclosed above add the capability of ‘releasing’ based on sensor input without having support personnel present. Automatically releasing the restraints may also speed recovery time, which is generally beneficial for all payloads. A further use of the system is to allow for mid-air release if this is desired, such as when airdropping watercraft.

It should be noted that the automatic single point release system of the present invention constitutes various improvements over the release system disclosed in U.S. Pat. No. 8,414,235. Except as described otherwise herein, various latches and other features may be similar to the latches disclosed in the above patent and therefore the disclosure of U.S. Pat. No. 8,414,235 is incorporated herein by reference in its entirety.

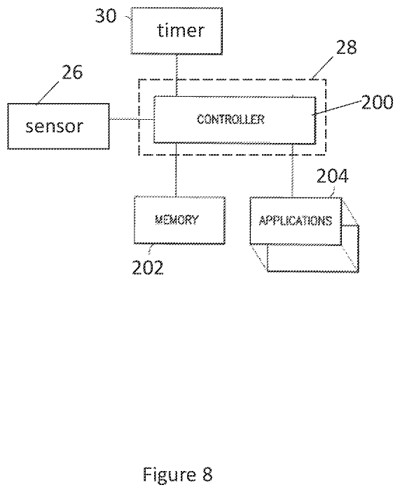

Referring now also to FIG. 8 the control circuit 28 of the control box 20, 120 generally comprises a controller 200 such as a microprocessor for example. The electronic circuitry includes a memory 202 coupled to the controller 200, such as on a printed circuit board for example. The memory could include multiple memories including removable memory modules for example. The device may have applications 204, such as software. The sensors/timer 26, 30 are also coupled to the controller 200. The system 10, 110 may be preferably programmed to automatically release the latches 16, 116 when the sensors/timer (together with the control circuit) determine that a release condition (which may be predetermined) has been met.

While various exemplary embodiments have been described in connection with the control box comprising four control cables corresponding to four securement modules (with each securement module comprising a latch and a pair of straps), one skilled in the art will appreciate that the various exemplary embodiments are not necessarily so limited and alternate embodiments may provide a control box with more than four control cables and a corresponding number of securement modules.

Below are provided further descriptions of various non-limiting, exemplary embodiments. The below-described exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

In one exemplary embodiment, an automatic single point release system comprising: a platform; a plurality of securement modules mounted to said platform, each said module comprising: a first strap anchored to said platform; a second strap anchored to said platform; and a latch connected between the first strap and the second strap, wherein the latch comprises a releasable latch arm, a rocker arm, and a control cable, wherein the control cable is configured to control a position of the rocker arm, and wherein the latch arm is configured to be attachable and releaseable to a payload on the platform in response to the position of the rocker arm; a control box mounted to the platform, wherein the control box is connected to each control cable, wherein the control box is configured to automatically and concurrently release each said latch in response to a predetermined condition.

The automatic single point release system as above wherein the control cable comprises a mechanical cable.

The automatic single point release system as above wherein the control cable comprises an electrical cable.

The automatic single point release system as above wherein there are at least four securement modules.

The automatic single point release system as above wherein the control box comprises a control circuit, and sensor, and/or a timer.

The automatic single point release system as above wherein the sensor comprises a pressure altimeter and/or accelerometers.

In another exemplary embodiment, an automatic single point release system, comprising: a securement module comprising a latch; a control box connected to the latch, wherein the control box comprises a sensor; at least one processor; and at least one memory including computer program code, the at least one memory and the computer program code configured to, with the at least one processor, cause the system to perform at least the following: determine a release condition; and trigger the latch to move to a release position in response to the determined release condition.

In another exemplary embodiment, a computer program product comprising a computer-readable medium bearing computer program code embodied therein for use with a computer, the computer program code comprising: code for determining a release condition; and code for triggering a latch to move to a release position in response to the determined release condition.

It should be understood that components of the invention can be operationally coupled or connected and that any number or combination of intervening elements can exist (including no intervening elements). The connections can be direct or indirect and additionally there can merely be a functional relationship between components.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

1. An automatic single point release system comprising:
a platform;
a plurality of securement modules mounted to said platform, each said module comprising:
a first strap anchored to said platform;
a second strap anchored to said platform; and
a latch connected between the first strap and the second strap, wherein the latch comprises a releasable latch arm, a rocker arm, and a control cable, wherein the control cable is configured to control a position of the rocker arm, and wherein the latch arm is configured to be attachable and releaseable to a payload on the platform in response to the position of the rocker arm;
a control box mounted to the platform, wherein the control box is connected to each control cable, wherein the control box is configured to automatically and concurrently release each said latch in response to a predetermined condition.

2. The automatic single point release system of claim 1 wherein the control cable comprises a mechanical cable.

3. The automatic single point release system of claim 1 wherein the control cable comprises an electrical cable.

4. The automatic single point release system of claim 1 wherein there are at least four securement modules.

5. The automatic single point release system of claim 1 wherein the control box comprises a control circuit, and sensor, and/or a timer.

6. The automatic single point release system of claim 5 wherein the sensor comprises a pressure altimeter and/or accelerometers.

7. An automatic single point release system, comprising:
a securement module comprising a latch;
a control box connected to the latch, wherein the control box comprises a sensor;
at least one processor; and
at least one memory including computer program code
the at least one memory and the computer program code configured to, with the at least one processor, cause the system to perform at least the following:
determine a release condition; and
trigger the latch to move to a release position in response to the determined release condition.

8. A computer program product comprising a computer-readable medium bearing computer program code embodied therein for use with a computer, the computer program code comprising:
code for determining a release condition; and
code for triggering a latch to move to a release position in response to the determined release condition.
